(19) United States
(12) Patent Application Publication
(10) Pub. No.: US 2015/0356831 A1
(43) Pub. Date: Dec. 10, 2015

(54) GAME SYSTEM

(71) Applicants: Olagoke Osibodu, London (GB); Adebayo Jekayinfa, Riverside, CA (US)

(72) Inventor: Olagoke Osibodu, London (GB)

(21) Appl. No.: 14/729,469

(22) Filed: Jun. 3, 2015

(30) Foreign Application Priority Data
Jun. 5, 2014 (GB) 1410044.0

(51) Int. Cl. G07F 17/32

(52) U.S. Cl. CPC G07F 17/3283; G07F 17/3237; G07F 17/3209; G07F 17/3218

(57) ABSTRACT

A game system comprising a control server, and a plurality of subscriber terminals (009) which are remote from the control server and which communicate with the control server over the internet or SMS protocols. The game system comprises first input means for a first game element, second input means (010) for a second game element, and third input means for a third game element. The control server requires a minimum of three subscribers per game, and subscribers wishing to play the game are required to input the first game element first and wait for feedback from the control server, then input the second game element second and wait for feedback from the control server, and then input the third game element third and wait for feedback from the control server. There are three of the first input means (010), three of the second input means, and three of the third input means. Each input means (010) gives one of a game idle mode, a game registration mode, and a game play mode. Each one of the subscriber terminals (009) also has three input means with each input means giving a game idle model (003), a game registration mode (005), and a game play mode (008). Also provided are tie break means (021) for breaking a tie between an even number of players.

This invention relates to a game system. The game system may be an interactive, real time computer game system using general purpose computers, tablets, and mobile devices or other similar “end user device(s)”. The game system may be an interactive game system requiring persons playing the game system to play in an interactive manner using decision-making strategy.

Many different types of systems are known ranging from simple board games to complicated electronic devices. There is always a need for a new game system and it is an aim of the present invention to provide one such game system.

Accordingly, in one non-limiting embodiment, the present invention provides a game system comprising a control server, and a plurality of subscriber terminals which are remote from the control server and which communicate with the control server over the Internet or short message service (SMS) protocols for the purpose of playing a game, the game system being such that:
(i) the game system comprises first input means for a first game element, second input means for a second game element, and third input means for a third game element;
(ii) the control server requires a minimum of three subscribers per game, and subscribers wishing to play the game are required to input the first game element first and wait for feedback from the control server, then input the second game element second and wait for feedback from the control server, and then input the third game element third and wait for feedback from the control server;
(iii) the game system comprises three of the first input means for the first game element, with each first input means giving one of an idle mode, a game registration mode, and a game play mode;
(iv) the game system comprises three of the second input means for the second game element, with each second input means giving one of a game idle mode, a game registration mode and a game play mode;
(v) the game system comprises three of the third input means for the third game element, with each third input means giving one of a game idle mode, a game registration mode, and a game play mode;
(vi) the game idle mode is such that it comprises a default operating mode part, a no-game active part, and a registrations accepted for a next game part;
(vii) the game registration mode is such that it is adapted to receive an input from persons wishing to play a game and to count the total number of persons wishing to play the game;
(viii) the game play mode is such that the first, second and third game elements are such that they require the subscribers to input a decision via the subscriber terminals with the decision being a decision of one of two alternatives;
(ix) each one of the subscriber terminals also has three input means with each input means giving a game idle mode, a game registration mode, and a game play mode which has the two alternatives;
(x) the game system comprises separation means that operates consequent upon the inputs from the subscribers from the first, second and third game elements, and separates the inputs of the subscribers into two alternative groups according to their choice of the two alternatives and such that a one point score is assigned to those subscribers whose input makes up the smallest alternative group of the two alternatives, and a zero point score is assigned to those subscribers whose input makes up the largest alternative group of the two alternatives;
(xi) the game system comprises progression means that progresses only those subscribers that are in the smallest group of the two alternatives in that round and that have scored the highest cumulative point score of one, two or three in that round;
(xii) the separation means is also such that it determines the overall winner of the game as being the person who has been in all the smallest groups, is the last person remaining in the game, and is the person who registered earliest of those persons in that round;
(xiii) the subscriber terminals comprise tie break means for breaking a tie between even numbers of players, the tie break means for breaking the tie being such that it allows a previous potential player who has been frozen out from a game to be admitted to the game; and
(xiv) the game system is such that it comprises a game format in which the overall winner of a game is decided on a specific instance of the game given the scenario that multiple instances of the game are able to be played simultaneously.

The game system may comprise of software programming logic located on a central or host computer server, and a plurality of end user devices remote from the host server and communicating with the host server over the Internet or through short message services (SMS) protocol. A game engine on the hosted server may also send communication to the end user devices.

Aspects of the invention may relate to auditing and security to ensure fairness for the players and to prevent players from defeating the outcome of a game. The game system may enable fast efficient communication with reliable synchronous operation and accounting players may play several variations of the game.

Other embodiments of the invention include apparatus, and computer programs, configured to perform the actions of the game system and encoded on computer storage devices.

The game system of the present invention is advantageous in that it is able to be played in a wireless manner, with a large number of subscriber terminals at different places. The system of the present invention is thus able to enable games to be played on a national or international basis. Games played on the game system are simple yet interesting.

The game system may be one in which the game format comprises the following three game platforms;
(i) automatic invitation game (AIG);
(ii) private group game (PGG);
(iii) interconnected game combining AIG and PGG.

The game may be one which is such as to provide players with an objective of trying to accumulate and bank as many points as possible within a set time in the game format.

The game system may be one in which registered players can invite others (e.g. friends and family) to PGG games but still be connected to the game format such that the various inputs have effect and outcomes both for the PGG and the game format.

The players in a majority batch that is of a frozen status in a game may leave that particular game and join another game but forfeit at least one point.

The game system may be such that intending players can join an ongoing AIG at any round of the game.

The game system may be such that players in the game format can invite others to join an ongoing game.

The game system may be one in which points of accumulation are complemented by a credit and debit system whereby players who leave a game to join another game in the game format lose at least one point, and the first player to accept a “defrost” overture gains at least one point.

The game system may include a bank features where players are able to save their points and redeem their points. The game may then be such that only points banked are redeemable, and with the options donate, share or trade.

The game system may be one in which a vote input represents graphically a colour code 3D image object, and in which the overall voting image forms a collage of colours or a 3D image. The collage or 3D image may be downloadable and printable for a consideration.

The game may be one in which a frozen player is able to override such status by losing at least one point each time, and with a maximum of three overrides or moves within the game format.

The game system may be one which is such as to provide a dynamic format of trade mark and barter, debit and credit and banking features.

The answers required by the game system during the playing of a game are a choice of one of two alternatives. The game system is preferably one in which the two alternatives are Yes and No. Other alternatives may be employed such for example as Higher and Lower, or Faster and Slower.

The control server may include details of a prize to be awarded to the winner of a game.

The prize awarded to the winner of a game may be any suitable and appropriate prize. Preferably, the prize is a business assistance package. The business assistance package may include business advice and/or finance. The business assistance package may be variable to suit the requirements of different winners.

The game registration mode may include an indication part for starting a new game, a registration part for processing registrations for a current game, and a disabling part for disabling voting.

The game idle mode may include a disabling part for disabling voting, and a registrations part for accepting registrations for the next game only.

The game play mode may include a playing part for each round/opportunity, an enabling part for enabling voting, and a registration part for processing registrations for the next game only.

The game system may be one in which subscriber registration is in two parts, with one part being for registering new subscribers for a game, and the other part being for registering existing subscribers for a game.

In one embodiment of the invention, the game system is one in which the game system game apparatus operates in a global satellite mode, in which the subscriber terminals are subscriber mobile telephones, and in which the subscribers play the game by texting from their mobile telephones.

In another embodiment of the invention, the game system is one in which the game system operates in an Internet mode, in which the subscriber terminals are Internet subscriber terminals, and in which the subscribers play the game via their Internet subscriber terminals.

The Internet subscriber terminals may be personal computers or lap top computers. Alternatively, the Internet subscriber terminals may be mobile telephones, tablets, lab top computers, Ipads or other mobile devices, all having an Internet capability, and in which the game is played using a web browser or an app on the mobile telephones, tablets, lap top computers, Ipads or other mobile devices.

In another embodiment of the invention, the game system is one in which the game system operates in a television game show mode, and in which the subscriber terminals are game show subscriber terminals used for the purpose of playing the game on television.

In another embodiment of the invention, the game system is one in which the game system operates in a casino gaming machine or a host server, and in which the subscriber terminals are other casino gaming machines.

The first game element may represent the status of a subscriber (i.e. a player) at birth. Some persons are born to rich families, some persons are born into families with royal lineage, but most persons are born into a humble background. As individuals, these persons are not able to choose their identity. Thus it was by chance who the person was and where the person came from. This is a life period of dependence and emotions. It is the first game element to be played in games played with the game system of the present invention.

The second game element may represent knowledge and information acquired by whatever format, as the personalities of players evolve. More specifically, persons become more aware of interpretations such for example as good and bad, beautiful and ugly, black and white, yes and no. As a result, informed decisions are able to be taken regardless of consequences or outcome. This stage represents independence and skills. This is the second game element to be played in a game played with the game system.

The third game element may represent the final stage in the life of a player. The third game element may complement the second game element. In the third game element, most individuals in life are struggling for survival, and combining needs, wants and desires. Hard decisions often need to be taken at some point, relying on competence and character to guide the strategic decision-making process. Sometimes decisions turn out to the right and sometimes decision turn out to be wrong. Experience is the best teacher for this third and last game element.

In accordance with the present invention, games may be played using the game system such that there is facilitated self-determined individual challenges. The games played using the game system may allow for certain levels of sustained interest in the game. Games played using the game system may also create good opportunities for whose players/subscribers who are more determined to win prizes.

In accordance with the present invention, games played using the game system may allow for promotion and marketing of other products that are not related to the game. Games played using the game system may also be used for training purposes in corporate decision making.

Those persons who have not won in various rounds as games are played with the game system may be given increased opportunities to win prizes, depending upon how fast the players are able to acquire points accruable from playing several games. The total number of points accrued may depend upon which playing round the players were frozen or eliminated from a particular game. The more games a person plays, the more points that are accrued.

Points may be redeemed by way of prizes which require a certain amount of points. A typical prize structure may be as follows.

### First Prize

The first person to register for a particular game gets this prize. Points are not required. Only one person can win this prize.

### Enterprise Prize

This prize may be redeemed by a player acquiring a certain number of points, for example 290 points. An unlimited number of players may redeem this prize. The prize may only be redeemed if the points are presented within a specified period. Various terms and conditions may be arranged to apply.

### Strategist Prize

This prize may be obtained by a player acquiring a predetermined number of points, for example 710. Various terms and conditions may be associated with obtaining this prize.

Embodiments of the invention will now be described solely by way of example and with reference to the accompanying drawings in which:

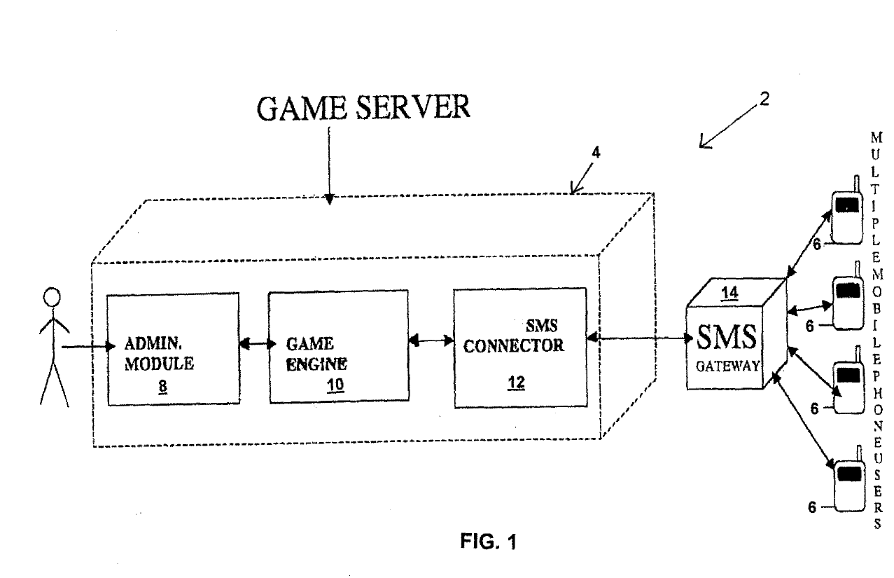

FIG. 1 shows a game system;

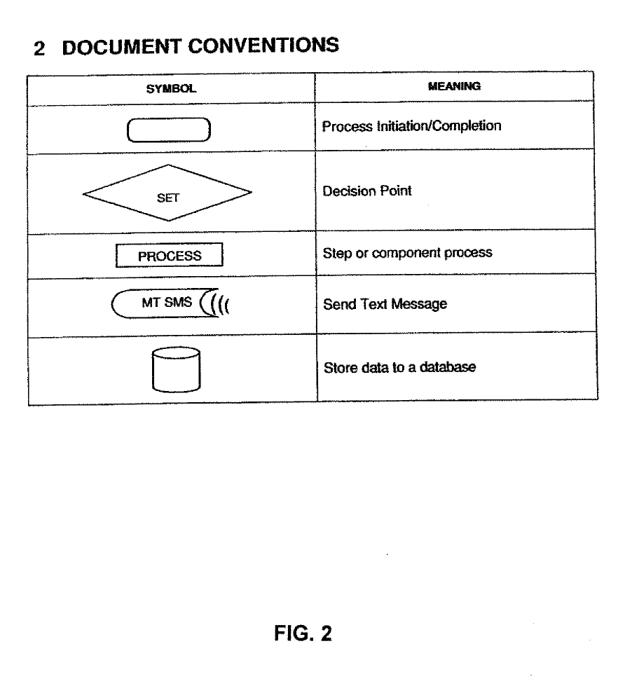

FIG. 2 shows symbol conventions used in subsequent Figures;

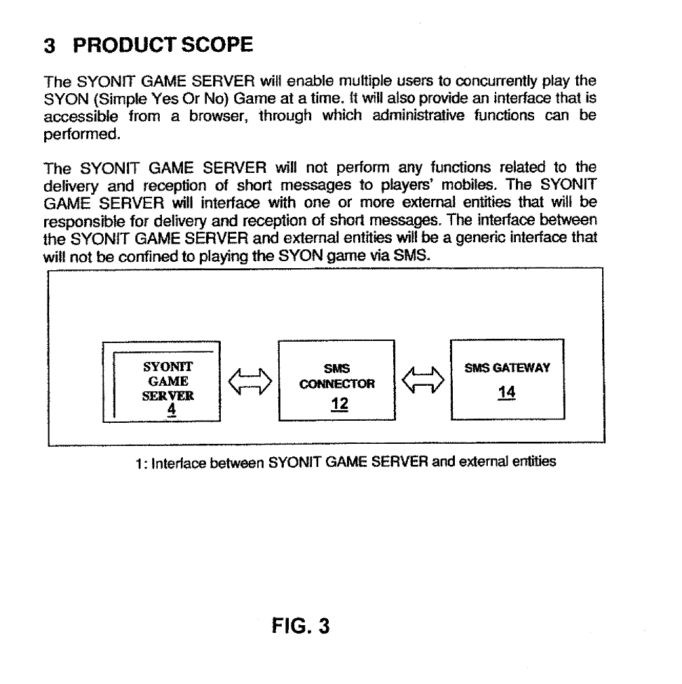

FIG. 3 illustrates connections between parts of the game system shown in FIG. 1;

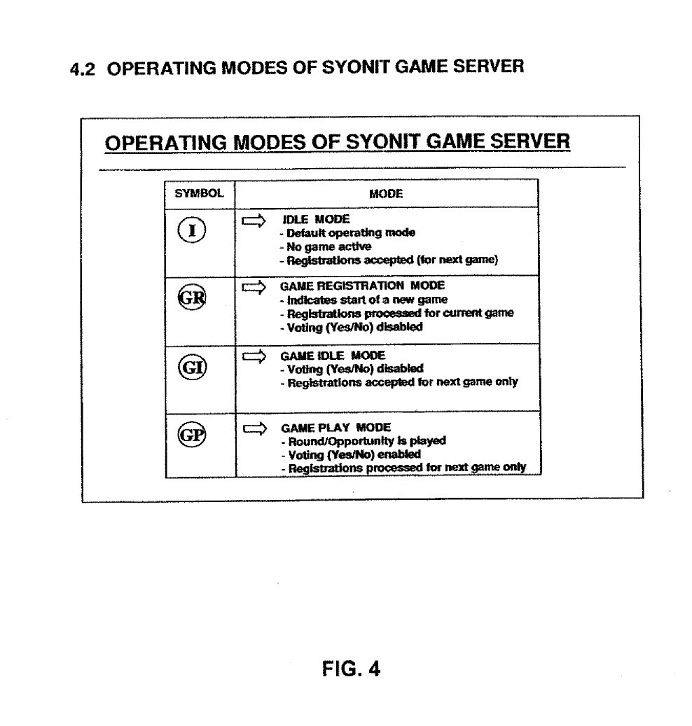

FIG. 4 shows operating modes of a control server part of the game system shown in FIG. 1;

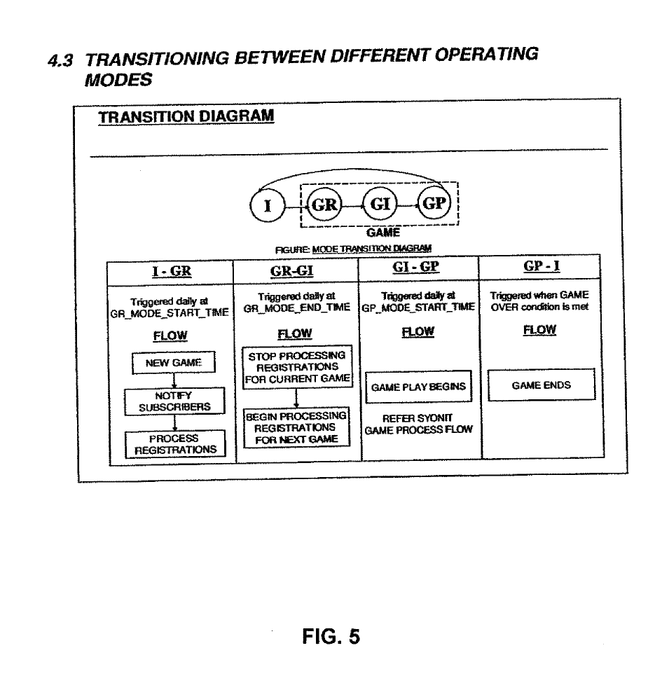

FIG. 5 shows transitions between different operating modes of the game system shown in FIG. 1;

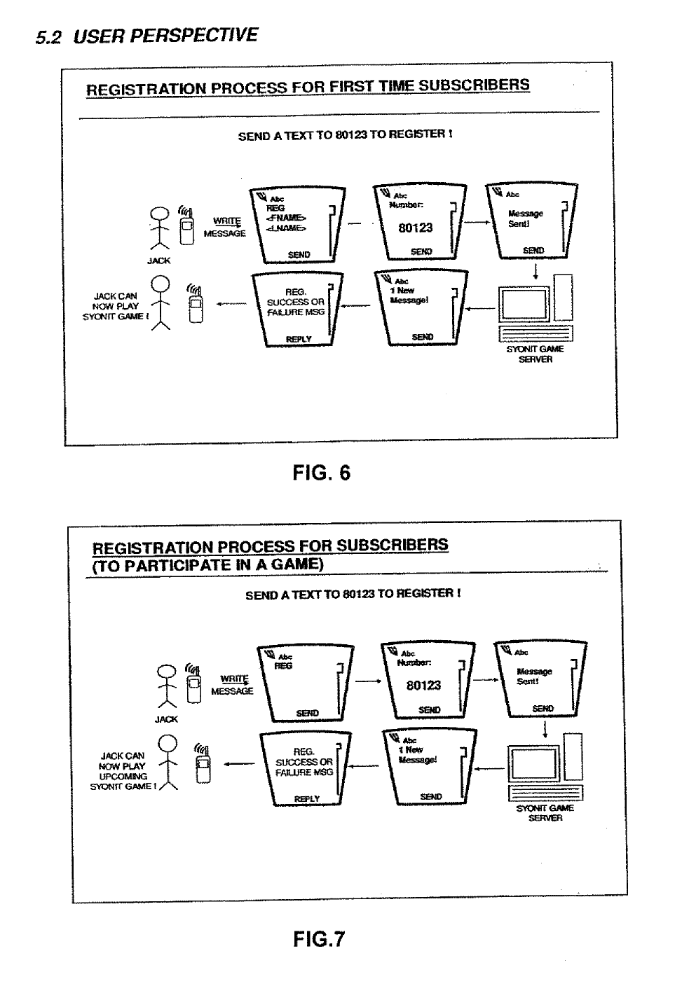

FIG. 6 illustrates part of the game system as used for registering first time subscribers;

FIG. 7 shows part of the game system as used for registering existing subscribers for participating in a game;

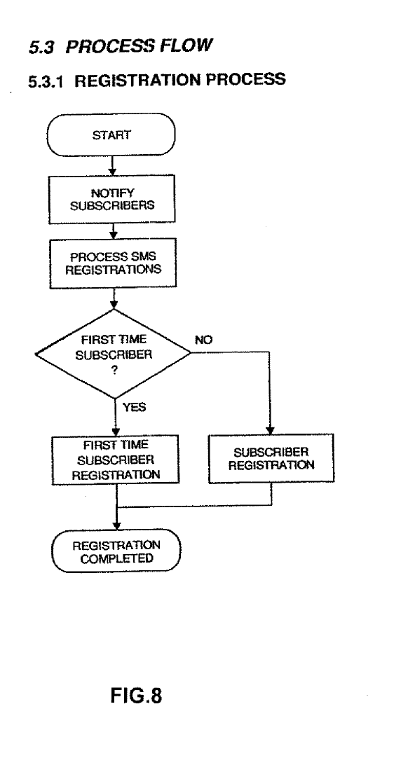

FIGS. 8-28 illustrate the operation of various parts of the game system, the game system being provided with appropriate hardware means and software program means for carrying out the various illustrated process steps;

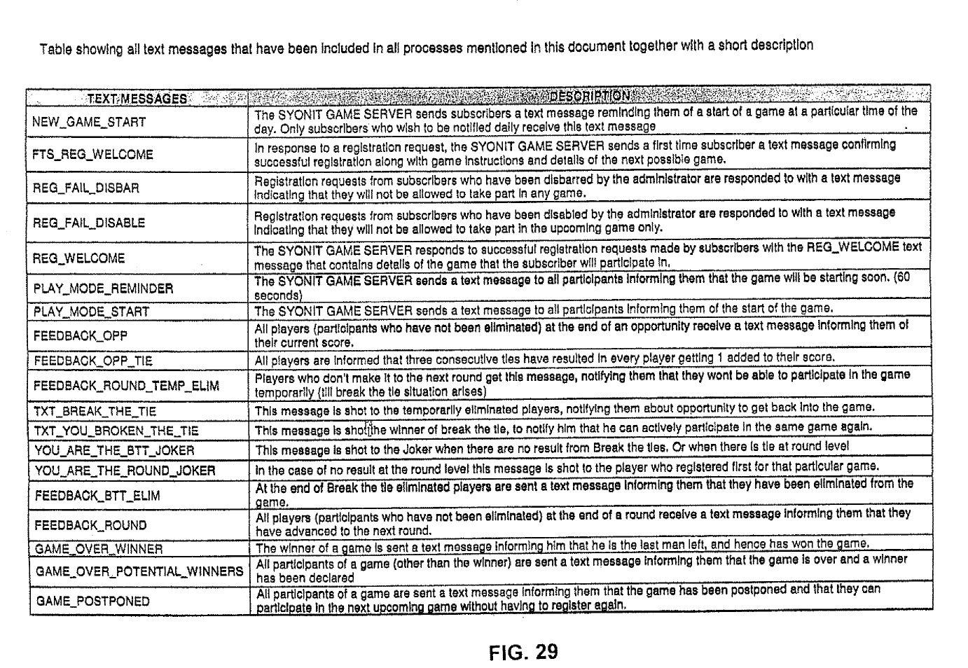

FIG. 29 is a table showing text messages included in process steps shown in previous Figures;

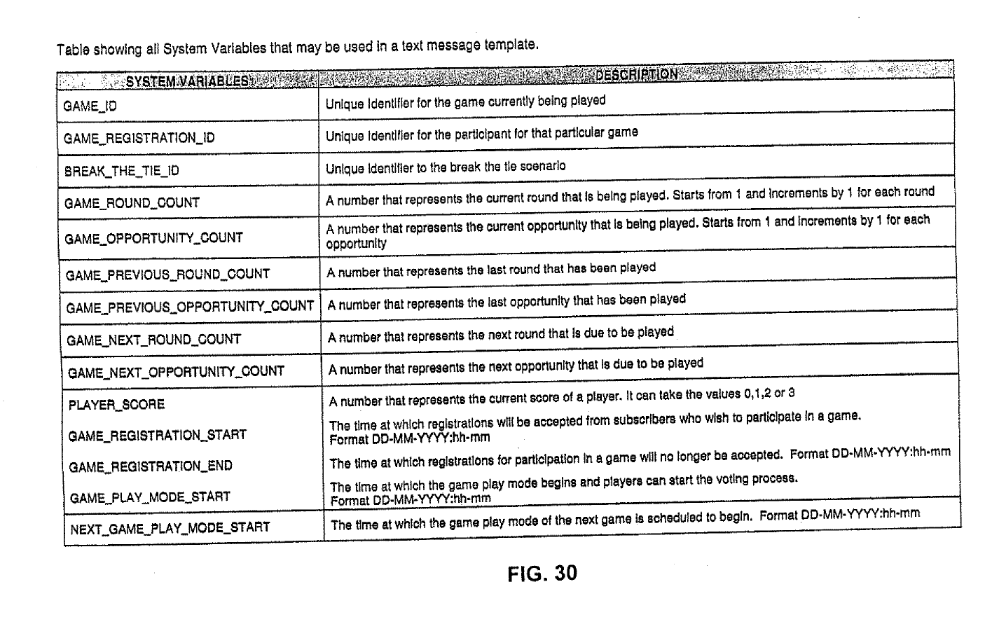

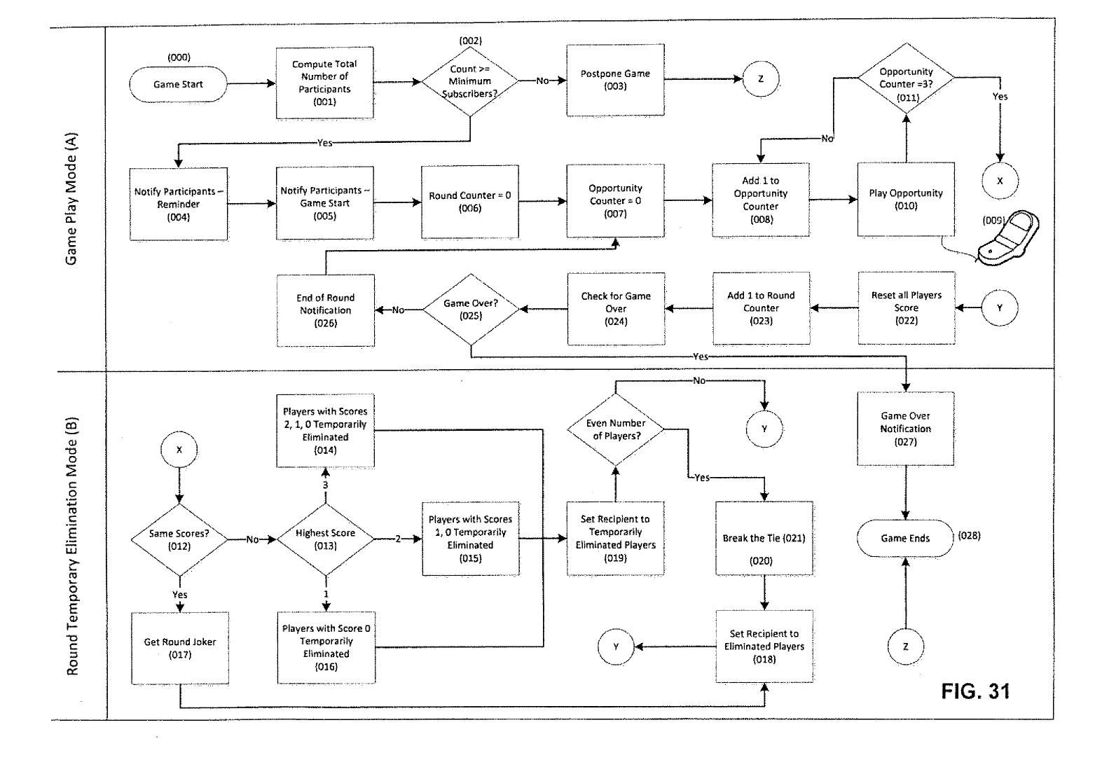

FIG. 30 is a table showing apparatus variables that may be used in a text message template; and

FIG. 31 is a high level flow diagram for a single game instance with a game system of the present invention.

Referring to FIG. 1, there is shown a game system 2 comprising a control server 4 for a game to be played, and a plurality of subscriber terminals 6. The subscriber terminals 6 are remote from the control server 4 and they are connectable to the control server 4 for the purpose of playing a game.

The game information in the control server 4 is such that it comprises a first game element, a second game element, and a third game element. The control server 4 is such that it requires subscribers wishing to play the game to play the first game element first, the second game element second, and the third game element third. The first, second and third game elements are such that they require the subscribers to give answers via the subscriber terminals with the answers being a choice of one of two alternatives, that is a choice of Yes or No. The game played using the game system 2 is such that it is played in rounds with the winners of each round being those subscribers in a group of subscribers that was the smallest group of subscribers in that round. The overall winner of a game is the person who has been in all of the smallest rounds and is the last person remaining in the game.

As shown in FIG. 1, the control server 4 comprises an administration module 8, a game server 10 and a short message service (SMS) connector 12. The connector 12 connects to a short message service gateway 14. The gateway 14 connects in a radio-frequency manner to the subscriber terminals 6. As shown, the subscriber terminals 6 are in the form of mobile telephones. The game system 2 thus operates in a global satellite mode (GSM). The subscribers playing the game do so by texting the control server 4 from their mobile telephones. The control server 4 may be regarded as a game server.

Referring now to FIG. 2, there are shown symbols and their meanings, the symbols being used in subsequent Figures.

FIG. 3 shows a modification to part of FIG. 1. In FIG. 3, it will be seen that the connector 12 may be regarded as being external to the control server 4 in the form of the game server.

Generally, the control server 4 enables multiple users to play a game at the same time. The control server 4 also provides an interface that is accessible from a browser, through which administrative functions can be performed.

The control server 4 may operate such that it does not perform any functions related to the delivery and reception of short messages to the subscriber terminal 6 in the form of the mobile telephones. The control server 4 may interface with one or more external entities that are responsible for the delivery and reception of the short messages. The interface between the control server 4 and the external entities may be a generic interface that is not confined to playing the game via texting on a short message service.

FIG. 4 shows self-explanatory operating modes of the control server 4.

FIG. 5 is a transition diagram showing transiting between different operating modes of the game system 2.

FIG. 6 shows the registration process that operates for first time subscribers. FIG. 7 shows the registration process that operates for existing subscribers wishing to participate in a game.

FIG. 8 shows in flow chart form the steps required for registration.

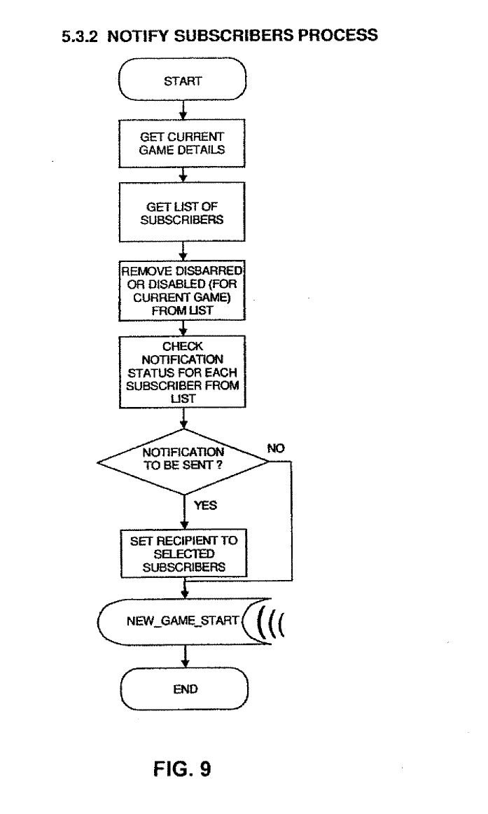

FIG. 9 shows in flow chart form the steps required for checking and notifying existing subscribers for a new game.

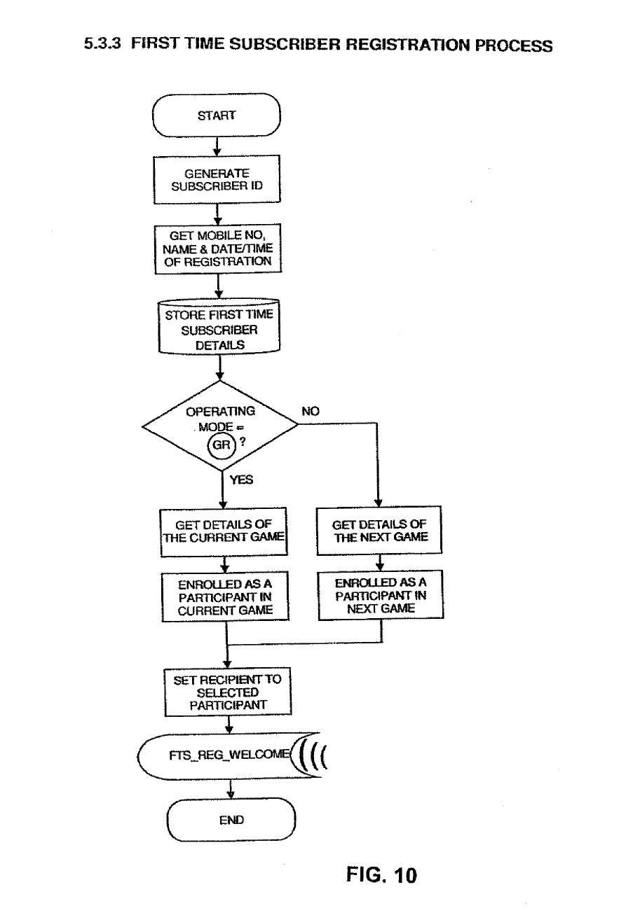

FIG. 10 shows in flow chart form the steps taken for registering and enrolling first time subscribers.

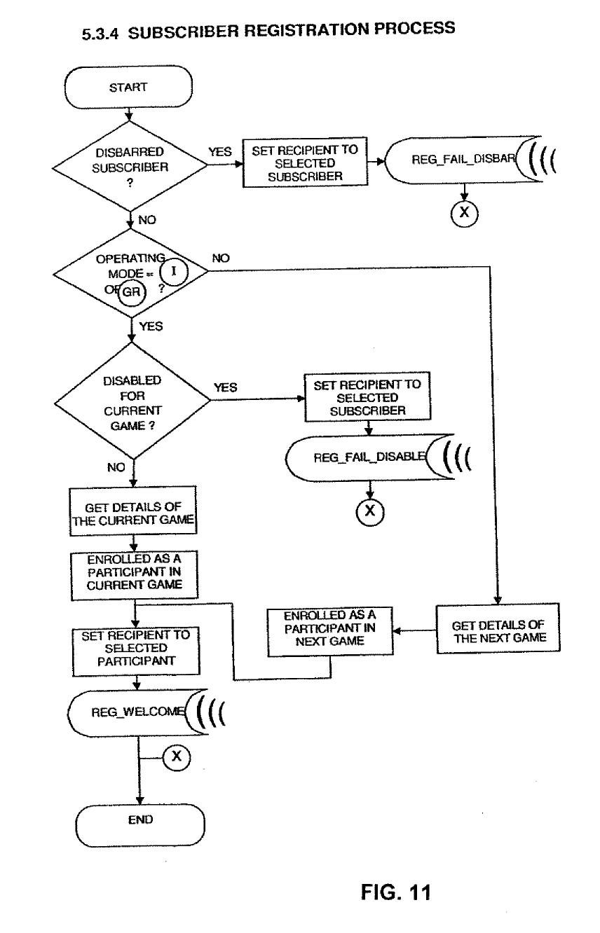

FIG. 11 shows the steps for a subscriber registration process.

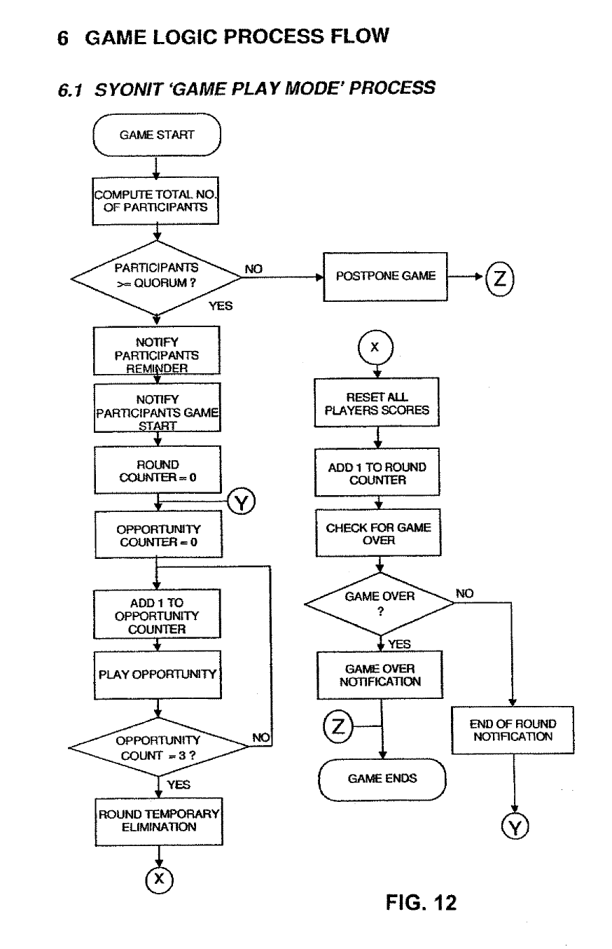

FIG. 12 shows the steps for operation of the game system 2 in a game play mode as referred to above in connection with FIG. 4.

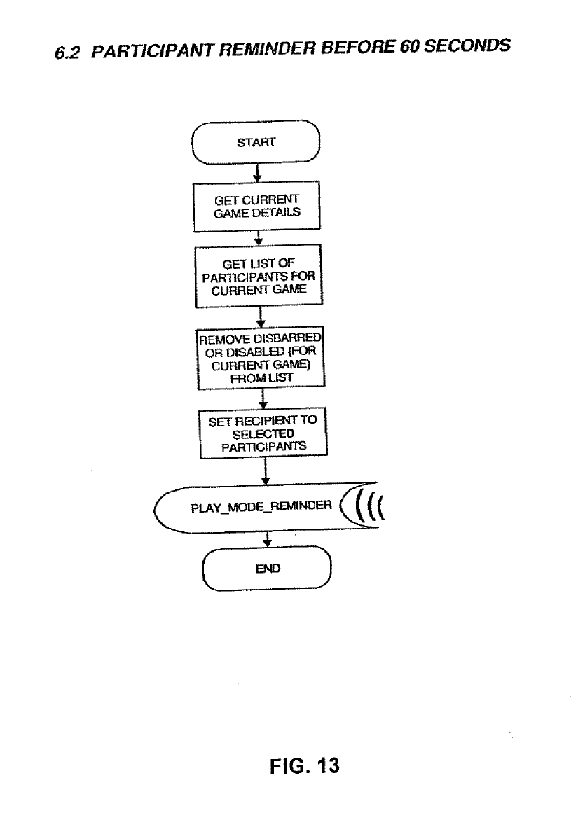

FIG. 13 shows steps required for giving a subscriber a reminder for 60 seconds.

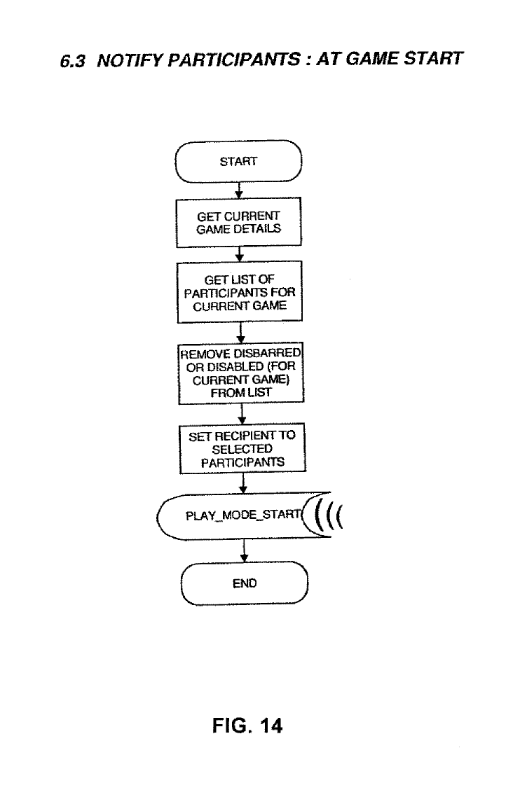

FIG. 14 shows the steps required for notifying participants at the start of a game.

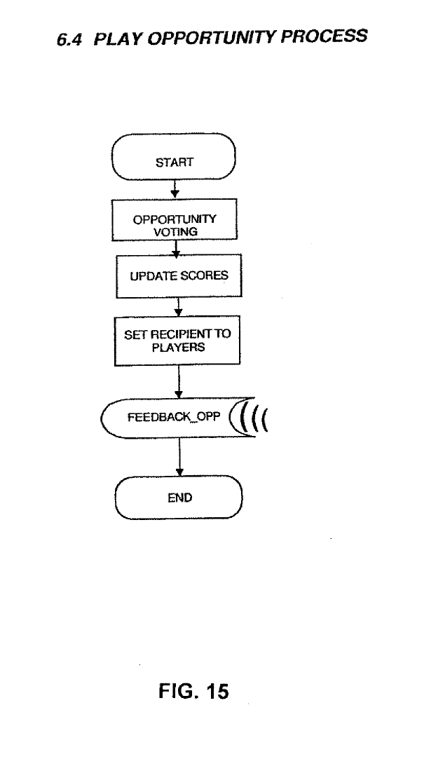

FIG. 15 illustrates subscriber/player opportunity process steps.

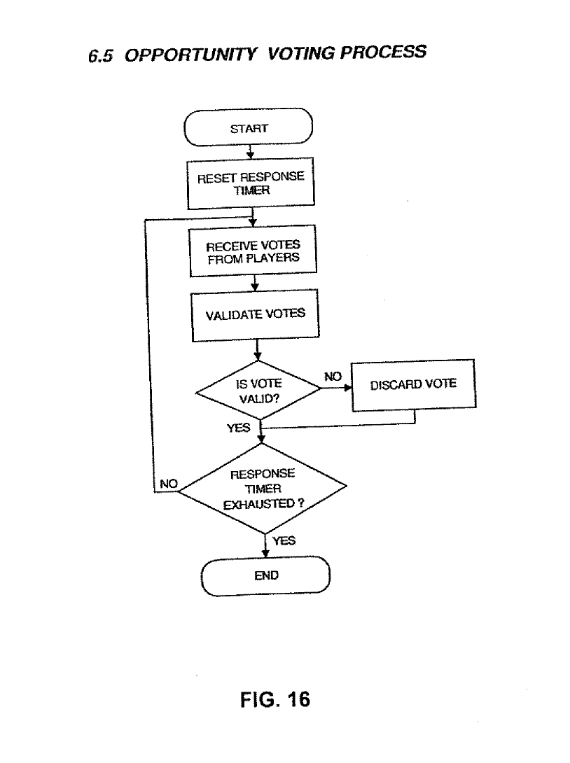

FIG. 16 shows subscriber/player opportunity voting process steps.

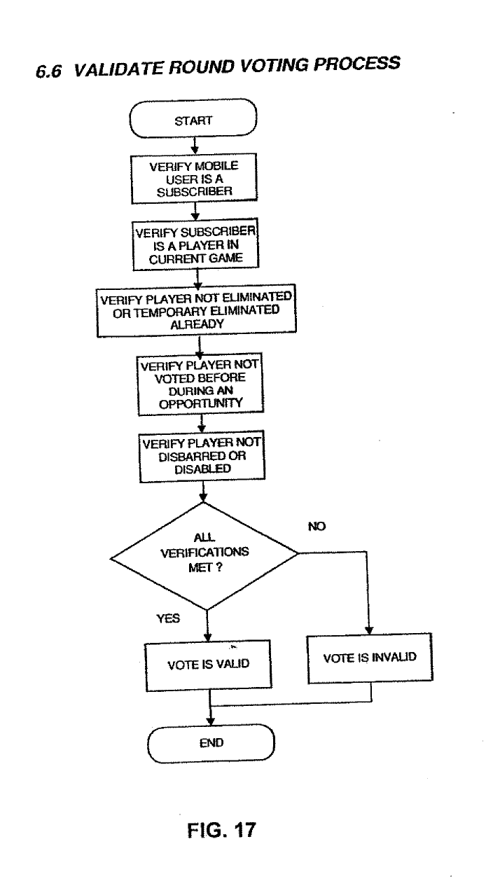

FIG. 17 shows the steps for validating the voting process in a game round.

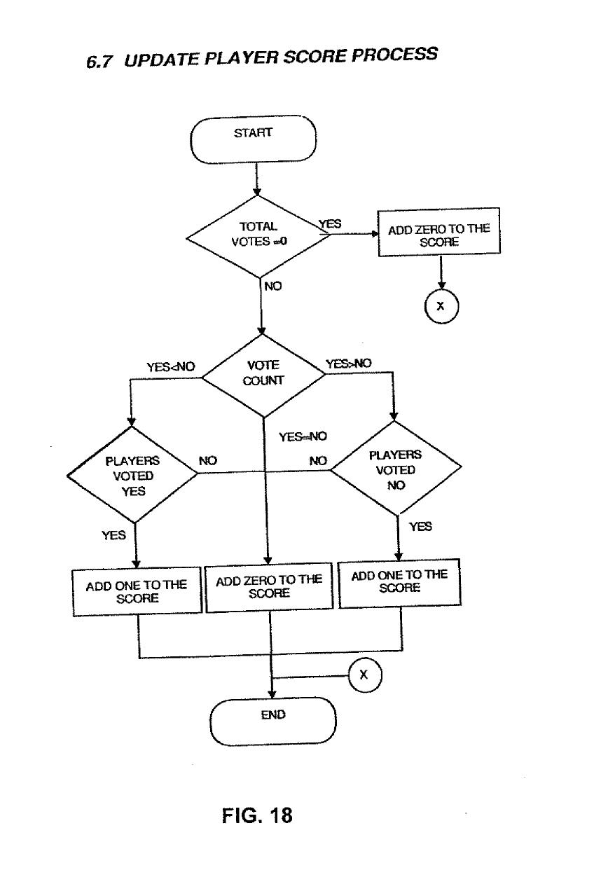

FIG. 18 shows the process steps for updating a player's score.

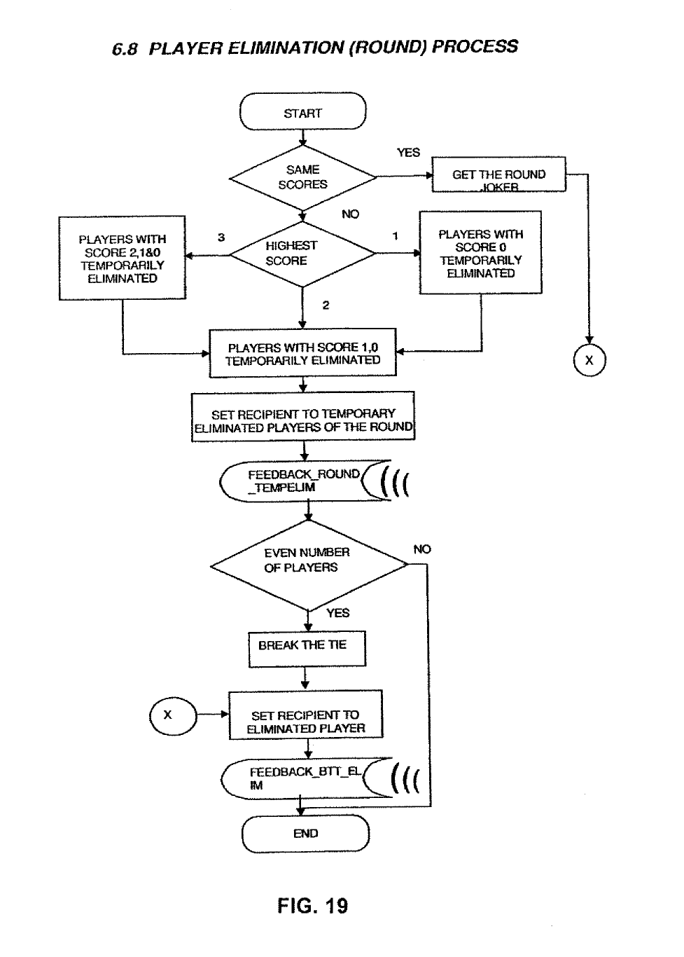

FIG. 19 shows the process steps for showing the elimination of a player in a round.

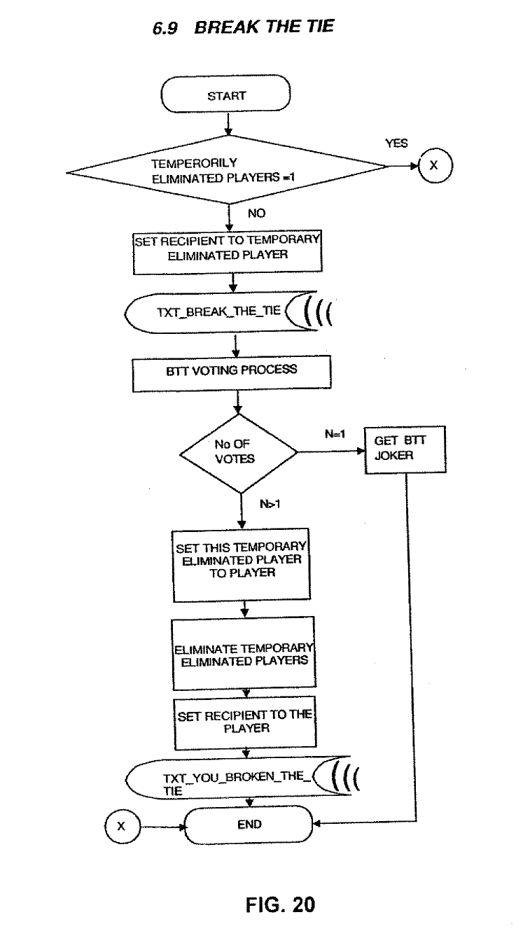

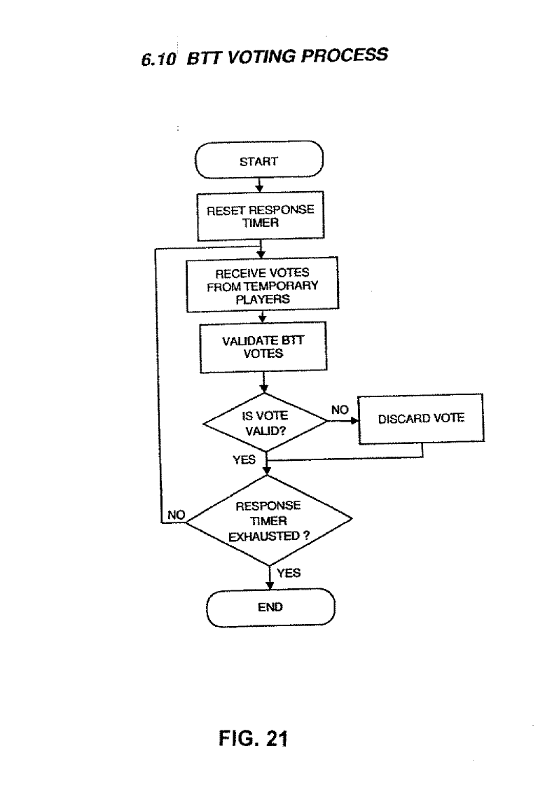

FIG. 20 shows the process steps for breaking a tie in the event of a tie between two or more players.

FIG. 21 shows voting steps for the process of breaking a tie.

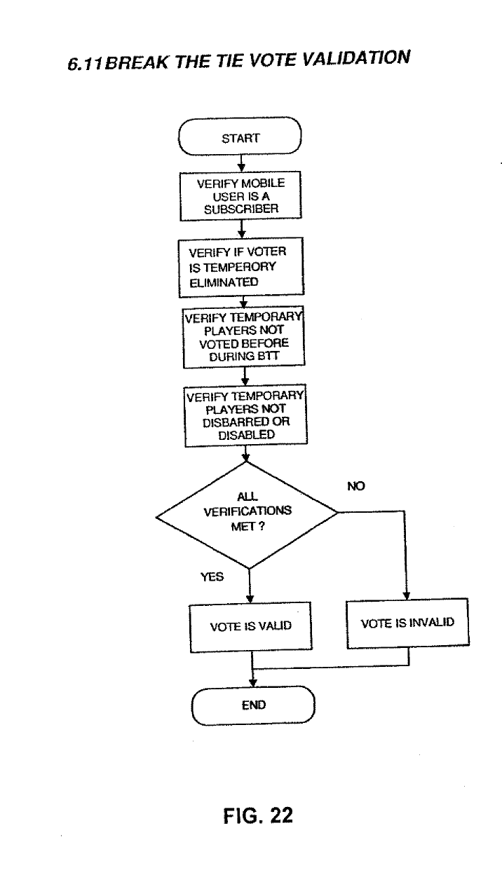

FIG. 22 shows the steps for validating a breaking the tie vote.

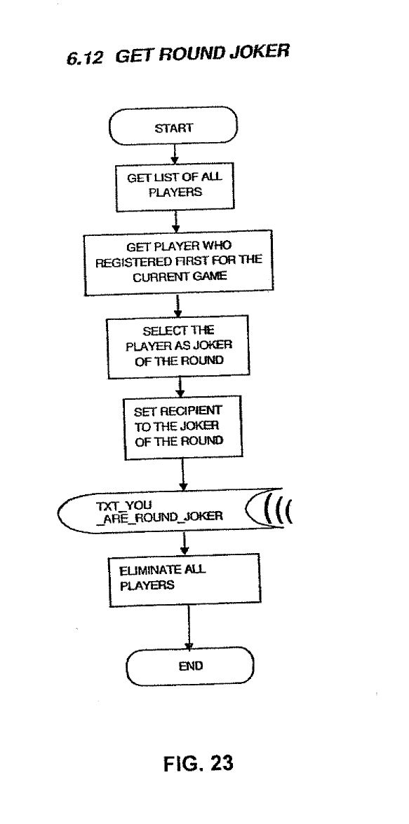

FIG. 23 shows joker steps that may be employed during the playing of a game with the game system 2.

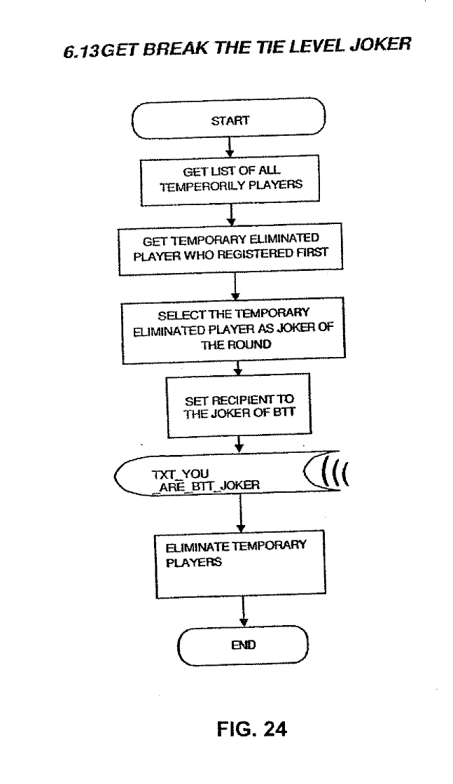

FIG. 24 shows breaking the tie steps in the event that the joker mode of FIG. 23 is employed.

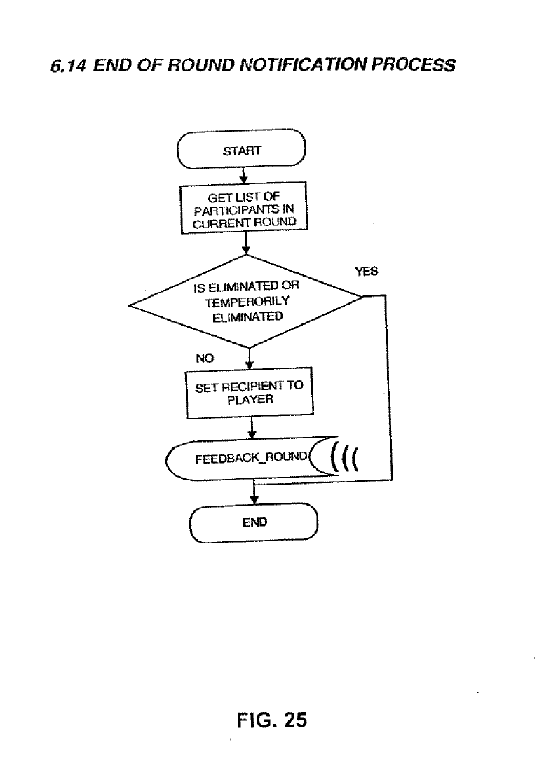

FIG. 25 shows end of round notification steps.

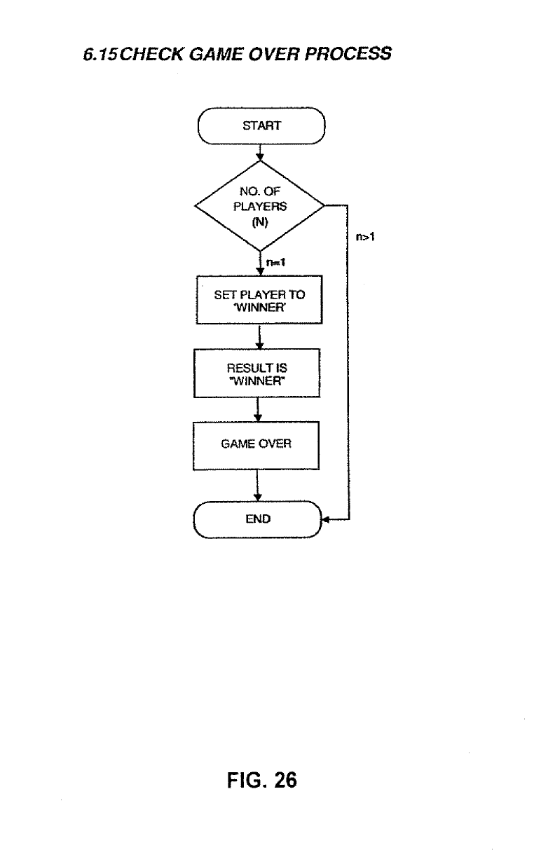

FIG. 26 shows checking steps at the end of a game.

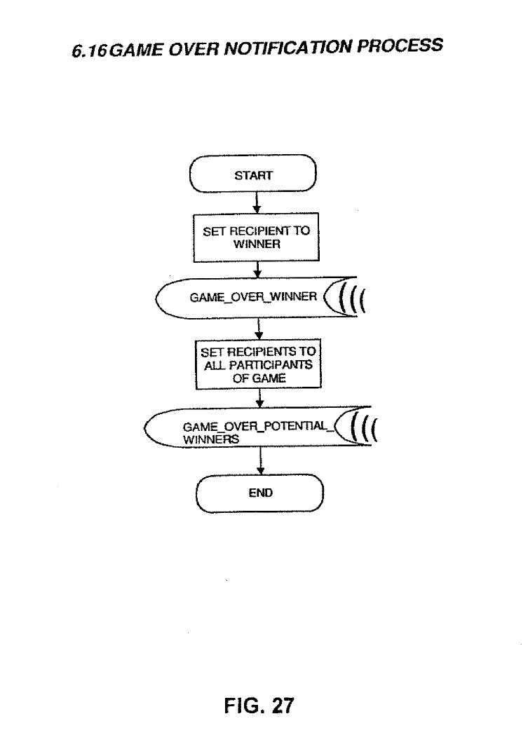

FIG. 27 shows player notification steps at the end of a game.

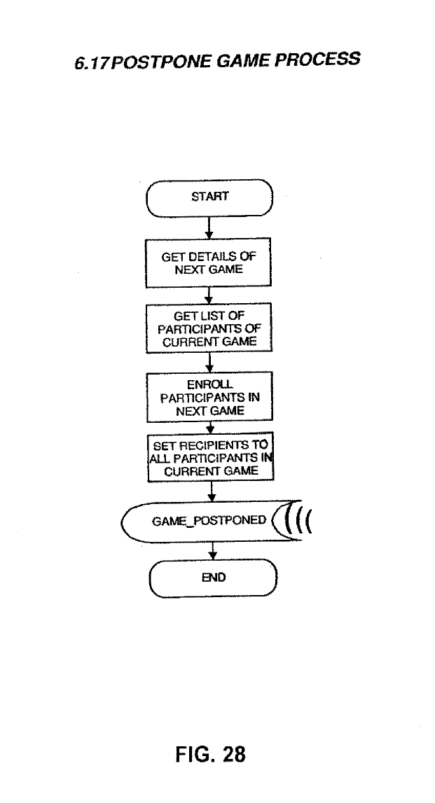

FIG. 28 shows steps for postponing a game.

FIG. 29 is a table showing text messages that may be used in the playing of a game with the game system 2.

FIG. 30 shows apparatus variables that may be employed in game system of the present invention.

A game played using the game system of the present invention and as shown by way of example in the drawings may be regarded as an eliminating game of chance provided by the first game element, of choice provided by the second game element, and of strategy provided by the third game element. It is a self-determining decision process of elimination. Players are required to choose and submit their choice of either Yes or No to eliminate others in a particular game. The aim is to be the last person standing. The game may be played by male and female persons of a wide variety of ages. Unlike existing game systems which may require only chance, games played in the game system of the present invention may be hybrid games because involving a combination of choice, chance and strategy.

A game is played as a series of eliminating rounds, within a predetermined time and period. Substantially unlimited numbers of players may play a game. Each player may have a maximum of three opportunities for a submission in an eliminating round. Other numbers of opportunities may be employed. In an eliminating round, the minority eliminates the majority. In other words, players forming the minority of either Yes or No submissions in a particular round qualify for the next round of elimination in the game. The remaining players (i.e. the majority) are frozen from that particular game. Successful players forming the new minority are thus required to choose and submit again for their choices. Again a new minority emerges from cumulative submissions, and the new minority qualifies for the next round. The remaining players (i.e. the majority) are frozen from the game at that round. The rounds are repeated and continue until a last person emerges as the winner of the game.

Unlike existing games, games played using the game system of the present invention are able to culminate in unique prizes for the winner. Thus, for example, each game may cumulate in the generation of funds to actualize viable business ideas to be submitted by the winner of game. There is thus long term potential for creating employment opportunities, for example for at least 29 people. The winner of a game becomes an entrepreneur or equity holder of a business idea. Funding for the business idea is able to be provided by owners or operators of the game system as a prize at the end of each game.

As indicated above, the simple Yes or No answers required during the playing of a game relate to certain factors of life, namely chance, choice and strategy. Survival, performance and achievement in life hinges partially on these factors of chance, choice and strategy. They also hinge on decision-making processes. In other words life is a game of chance, choice, strategy, decision and action. The game system of the present invention as described with reference to the drawings is, in effect, a wireless elimination game. As shown in the drawings, the game system may be played using mobile phones on any global satellite system. The playing of a game requires a registration consideration by way of a charge for the use of the short message service via the GSM mobile telephones. Games are able to be played with the game system by subscribers who register via SMS. These subscribers who register form the players for a specific game.

Entries are made through SMS after due registration. The owners or organizers of a game are able to send a feed back, also via SMS or web browser, to each successful subscriber at any stage on the process of a game, until completion when the last person remaining emerges as the winner. As can be appreciated from the above drawings, a game may be monitored both by the owners and organizers, or by a GSM operator on whose network a SMS is terminated. The duration for a game may be predetermined by a seller of the game, or it may be allowed to depend upon the play strategy of subscribers playing the game.

The simple choice of Yes or No may impart the following:
(a) an ability to shift paradigm and act.
(b) development of an individual's spirit of sportsmanship whether one wins or loses.
(c) development of an individual's responsibility to accept and cope with the outcome of that individual's decisions.
(d) strategic thinking in the processing of information.

By way of example, it is mentioned that an embodiment of game system of the present invention may be regarded as providing the following features.
(a) first to register gets a joker.
(b) break a tie between players.
(c) minority wins.
(d) a venture capital certificate is provided.
(e) expandable and unlimited numbers of entrants to a game, i.e. subscribers.
(f) alternative prizes.
(g) self-determining elimination process in the players of a game.
(h) no physical, audio or visual contact required with other playing subscribers.
(i) games are able to be played internationally and thus cross international borders.
(j) advantages are provided of multiple participation in games simultaneously running in different locations across different national and international borders.
(k) wireless contact across national and international borders.
(l) intangible format via satellite transmission or players can provide a game response over the internet.
(m) the purchase of additional equipment by subscribers to enter a game is not required. The players are just required to have a mobile telephone with a SMS capability or any Internet enable computer terminal/mobile device.

Games played using the game system of the present invention may be played with various rules. By way of example, the rules may be as follows.
(a) First to register has a joker.
(b) “Break the tie” format provides an opportunity for only one of the frozen entrants to re-enter the game when successful minority is an even number after an elimination round by SMS feedback with an assigned (“break the tie”) signature ring-tone (optional).
(c) An elimination has adjustable time-limit for submission depending on location and market factors.
(d) A signature ring-tone may be assigned to elimination feedback.
(e) Registration is required to participate in a specific game.
(f) Registration attracts a consideration.
(g) An odd number only of entrants may edge-off, i.e. eliminate, at any eliminating round.
(h) If an even number emerges as the minority, “break the tie” format adds one entrant from a batch of current, frozen entrants to make the total number an odd number 20.
(i) Except for the first elimination, all the other eliminations shall be played by a batch of odd number entrants.
(j) Non-submission of choice by qualified entrant(s) automatically form part of the majority, and are therefore eliminated from the game.
(k) Minority eliminates the majority to qualify for subsequent rounds of elimination.
(l) Registration period must be specific.
(m) Elimination rounds may not have a specific duration.
(n) Last person is the winner and he/she is qualified to choose a prize.
(o) There is prize money (immediate reward).
(p) Venture Capital Certificate—VCC (long-term benefit to last person)—grand prize.
(q) Last person is required to submit 2 viable business ideas—a prerequisite for VCC.
(r) Participation in a particular game is chargeable and may be the same as or at an extra above normal SMS rate (premium).
(s) Requires a wireless state of the art technology.
(t) Web connectivity for online version and other details.
(u) SMS consideration by way of charge may vary from country to country for local versions (franchise option).
(v) There may be only one global version solely owned by the seller/owner/inventors.
(w) Age limit-entrants may be 16 and above. Parents' permission/guidance may be required for players under 16.
(x) Details and profile of last person may be made available upon request.
(y) Details of every game may be made available on the web site on request.
(z) The seller/owner/inventors may reserve the right without prior notice to effect modifications and design changes to the game as part of a continuous program of game development.
(aa) A maximum of three opportunities per entrants for a submission in an edge-off (elimination round).

By way of example, it is mentioned that the game system of the present invention may be set up to operate as follows.

### Registration

(1) Registration opens 7 a.m. daily (may be adjusted depending on location and market factors)
(2) Text Entries trapped in Dbase—Attributes: Mobile No. ? Provider ? Date/Time Stamp ? Country?
(3) Users may also register by accessing a game system portal using a web browser over the internet
(4) Auto Response per Entry—Confirm Reg+Game Instructions.

(5) Reg closes 7 p.m. daily (may be adjusted depending on location and market factors).

### Game Starts: Elimination

(Each Round allows THREE Opportunities)
(6) Game Starts—Send Message/Ringtone (Player Hedge Off—Submit YES/NO).
(7) RDBMS—Responses trapped.
(8) Compute Yes/No individual volume results.
(9) If result falls in MAJORITY count, add ZERO, MINORITY add ONE.
(10) End of Opportunity—Feedback to Entrants.
(11) Loop to (5) above until 3 opportunities played.
(12) Computer Aggregate AND Volume Totals for ROUND.
(13) Entrant with Aggregate to THREE, automatically moves on to the next round.
(14) If Volume Totals for MINORITY is an EVEN number, go to “Break-The-Tie”, otherwise go to next step.
(15) Feedback to Entrants.

### “Break-the-Tie” Scenario

If totals for MINORITY is an EVEN number after 3 opportunities (ROUND), then Feedback to MAJORITY entrants. Additional chance to go to next round for ONE player—FIRST to submit a YES/NO response.
If all the entrants choose same value of “Yes” or “No”. The first batch of 50% of entrants to register for that particular game moves on to the next round. (Time based selection).
If there are only three entrants with same value after 3 opportunities (ROUNDS), the first entrant to register that particular game is the winner 24

Referring now to FIG. 31, there is shown an example high level process of a game system instance. In the game play mode (A) a game engine logic calculates the total number of participants 001 who have registered for this game instance. If the participants count is greater 002 than a minimum set level, e.g. three, then the game is allowed to proceed by sending a game reminder to the registered participants 004. Otherwise the game is postponed 003. In the case where the game is allowed to proceed, the registered participants are then sent a game start notification 005 to signify the start of the game and the game engine sets the round counter 006 to zero. The opportunity counter 007 is also set to zero. The game system adds one to the opportunity counter 008 to signify its readiness to receive a response for the first game element from each participant.

Each participant, e.g. subscriber, of this game instance plays at play opportunity 010 the first game element first. This is done by a sending response via a subscriber terminal 009 and by using the first input means with the response being a choice of one or two alternatives, that is a choice of yes or no. One point score is assigned to those subscribers whose input makes up the smallest alternative group of the two alternatives, and a zero point score is assigned to those subscribers whose input makes up the largest alternative group of the two alternatives. The subscriber terminal 009 may be a personal computer (e.g. PC, Mac) with a browser application or a mobile device (e.g. smart phone). In some examples, the subscriber terminal 009, e.g. the mobile device, can communicate with the game server over large scale telecommunication networks (e.g. GSM, CDMA, or IP-based networks such for example as the Internet) and/or smaller scale networks, such as WiFi, Bluetooth, wired, or infrared networks. While only one subscriber terminal 009 is shown, the techniques described herein can be used in association with systems that include any number of subscriber terminals 009, e.g. mobile devices or personal computers.

After receiving responses for the first game element, the game system checks if the opportunity counter 011 is equal to three. If not, the opportunity counter 011 proceeds by adding one to the opportunity counter 008. The game instance progresses by repeating the cycle 008, 009, 010, 011. The game engine receives the response from participants for the second game element during the second cycle, and then receives the response from participants for the third game element during the third cycle.

When the opportunity counter 011 is equal to three, the game system proceeds to the round temporary elimination mode (B) by grouping participants by scores and counting participants with same scores 012. The game system checks for the participant or group of participants with the highest score 013. If the highest score 013 is three, then the game system temporarily eliminates participants with scores of two, one and zero 014. If the highest score is two, then the game system temporarily eliminates participants with scores of one and zero 015. Otherwise if the highest score is one, the game system temporarily eliminates all participants with a score of zero 016. In the case where all participants have the same score 012, the game proceeds to a ‘get round joker’ 017 process in which the first person to register for the game wins that round by default. Notification is sent to the eliminated players 018, and the game proceeds to ‘reset all players’ score′ 022.

Once the temporarily eliminated players have been identified, the game system sends notifications to the temporarily eliminated participants 019. If the number of participants remaining in the game is an even number, a game system will proceed to run the ‘Break the Tie’ (BTT) process 021. Otherwise the game system will proceed to reset all of the remaining players' score 022, add one to the round counter 023 and then proceed to execute the ‘check for game over’ 024 logic.

If the game system executes the game logic 025 and resolves that the game is over, then a ‘game over notification’ 027 is sent to recipients and the game ends 028. Otherwise the end of round notification 026 is sent to the players remaining in the game, and a new round begins by going through the loop described above starting from opportunity counter 007 equal to zero.

It is to be appreciated that the embodiments of the invention described above with reference to the accompanying drawings have been given by way of example only and that modifications may be effected. Thus for example, the game system may operate in an Internet mode. In this case, the subscriber terminals will be Internet subscriber terminals, and the subscribers will play the game via their Internet subscriber terminals. The Internet subscriber terminals may be personal computers, lap top computers or mobile telephones having an Internet capability. The game system may alternatively operate in a television game show mode. In this case, the subscriber terminals will be game show subscriber terminals used for the purpose of playing the game on television. These game show subscriber terminals may be those provided in a television studio or they may be owned by players playing remote from the television studio. There may be different categories of prizes to those mentioned above, and the various categories of prizes may be altered periodically. Individual components shown in the drawings are not limited to use in their drawings and they may be used in other drawings and in all other aspects of the invention.

The game system of the present invention may be branded under the Trade Mark SYONIT.

1. A game system comprising a control server, and a plurality of subscriber terminals which are remote from the control server and which communicate with the control server over the Internet or short message service (SMS) protocols for the purpose of playing a game, the game system being such that:
(i) the game system comprises first input means for a first game element, second input means for a second game element, and third input means for a third game element;
(ii) the control server requires a minimum of three subscribers per game, and subscribers wishing to play the game are required to input the first game element first and wait for feedback from the control server, then input the second game element second and wait for feedback from the control server, and then input the third game element third and wait for feedback from the control server;
(iii) the game system comprises three of the first input means for the first game element, with each first input means giving one of an idle mode, a game registration mode, and a game play mode;
(iv) the game system comprises three of the second input means for the second game element, with each second input means giving one of a game idle mode, a game registration mode and a game play mode;
(v) the game system comprises three of the third input means for the third game element, with each third input means giving one of a game idle mode, a game registration mode, and a game play mode;
(vi) the game idle mode is such that it comprises a default operating mode part, a no-game active part, and a registrations accepted for a next game part;
(vii) the game registration mode is such that it is adapted to receive an input from persons wishing to play a game and to count the total number of persons wishing to play the game;
(viii) the game play mode is such that the first, second and third game elements are such that they require the subscribers to input a decision via the subscriber terminals with the decision being a decision of one of two alternatives;
(ix) each one of the subscriber terminals also has three input means with each input means giving a game idle mode, a game registration mode, and a game play mode which has the two alternatives;
(x) the game system comprises separation means that operates consequent upon the inputs from the subscribers from the first, second and third game elements, and separates the inputs of the subscribers into two alternative groups according to their choice of the two alternatives and such that a one point score is assigned to those subscribers whose input makes up the smallest alternative group of the two alternatives, and a zero point score is assigned to those subscribers whose input makes up the largest alternative group of the two alternatives;
(xi) the game system comprises progression means that progresses only those subscribers that are in the smallest group of the two alternatives in that round and that have scored the highest cumulative point score of one, two or three in that round;
(xii) the separation means is also such that it determines the overall winner of the game as being the person who has been in all the smallest groups, is the last person remaining in the game, and is the person who registered earliest of those persons in that round;
(xiii) the subscriber terminals comprise tie break means for breaking a tie between even numbers of players, the tie break means for breaking the tie being such that it allows a previous potential player who has been frozen out from a game to be admitted to the game; and
(xiv) the game system is such that it comprises a game format in which the overall winner of a game is decided on a specific instance of the game given the scenario that multiple instances of the game are able to be played simultaneously.

2. A game system according to claim 1 in which the game format comprises the following three game platforms:
(i) automatic invitation game (AIG);
(ii) private group game (PGG);
(iii) interconnected game combining AIG and PGG.

3. A game system according to claim 1 and which is such as to provide players with an objective of trying to accumulate and bank as many points as possible within a set time in the game format.

4. A game system according to claim 1 in which registered players can invite others to PGG games but still connected to the game format such that the various inputs have effect and outcomes both for the PGG and the game format.

5. A game system according to claim 1 in which players in a majority batch that is of a frozen status in a game can leave that particular game to join another game but forfeit at least one point.

6. A game system according to claim 1 in which intending players can join an ongoing AIG at any round of the game.

7. A game system according to claim 1 in which players in the game format can invite others to join an ongoing game.

8. A game system according to claim 1 in which points of accumulation are complemented by a credit and debit system whereby players who leave a game to join another game in the game format lose at least one point, and the first player to accept a “defrost” overture gains at least one point.

9. A game system according to claim 1 in including a bank feature where players are able to save their points and redeem their points.

10. A game system according to claim 9 in which only points banked are redeemable, and with the options donate, share or trade.

11. A game system according to claim 1 in which a vote input represents graphically a colour code 3D image object, and in which the overall voting input forms a collage of colours or a 3D image.

12. A game system according to claim 1 in which a frozen player is able to override such status by losing at least one point each time, and with a maximum of three overrides or moves within the game format.

13. A game system according to claim 1 in which the two alternatives are Yes and No.

14. A game system according claim 1 in which the game registration mode comprises an indication part for indicating the start of a new game, a registration part for processing registrations for a current game, and a disabling part for disabling voting.

15. A game system according to claim 1 in which the game idle mode comprises a disabling part for disabling voting, and a registration part for accepting registrations for the next game only.

16. A game system according to claim 1 in which the game play mode comprises a playing part for each round/opportunity, a voting enabled part, and a registration part for processing registrations for the next game only.

17. A game system according to claim 1 in which subscriber registration is in two parts, with one part being for registering new subscribers for a game, and the other part being for registering existing subscribers for a game.

18. A game system according to claim 1 in which the game system operates in a global satellite mode, in which the subscriber terminals are subscriber mobile telephones, and in which the subscribers play the game by texting from their mobile telephones.

19. A game system according claim 1 in which the game system operates in an Internet mode, in which the subscriber terminals are Internet subscriber terminals, and in which the subscribers play the game via their Internet subscriber terminals.

20. A game system according to claim 1 in which the game system operates in a television game show mode, and in which the subscriber terminals are game show subscriber terminals used for the purpose of playing the game on television.
